(19) United States
(12) Patent Application Publication
(10) Pub. No.: US 2023/0014585 A1
(43) Pub. Date: Jan. 19, 2023

(54) SYNCHRONOUS OPENING OR CLOSING THIN HINGE

(71) Applicant: Sinher Technology Inc., New Taipei (TW)

(72) Inventor: Yi-Chin TANG, New Taipei (TW)

(21) Appl. No.: 17/378,129

(22) Filed: Jul. 16, 2021

(51) Int. Cl. E05D 3/12

(52) U.S. Cl. CPC E05D 3/122

(57) ABSTRACT

A synchronous opening or closing thin hinge comprises a rotating part including a bracket and two arcuate movable members, and a torsion providing part providing a torque. Two tracks are provided on the bracket for the arcuate movable members which are formed with a guide groove to perform an arcuate trajectory displacement. The torsion providing part comprises two connecting rods displacing along the guide groove when the two arcuate movable members are displacing, two rotating shafts disposed in parallel and operated by the two connecting rods, and a swing member disposed between the two rotating shafts. The two rotating shafts are provided with a plurality of teeth. The swing member comprises two meshing parts meshing with the plurality of teeth. The two meshing parts engaging with different parts of the plurality of teeth as the two rotating shafts rotating, and the swing member swings between the two rotating shafts.

### FIELD OF THE INVENTION

The invention relates to a thin hinge, and more particularly to a synchronous opening or closing thin hinge.

### BACKGROUND OF THE INVENTION

The existing thin hinges are disclosed in patents US 20210011527A1, TW 202100883, TW 202102970, and TW 202103540. For example, US 20210011527A1 provides the hinge device comprising a base, two arcuate brackets provided on the base, and a synchronous gear assembly provided on the base and connected to the two arcuate brackets. The two arcuate brackets are respectively provided with a plurality of teeth. The synchronous gear assembly comprises two rotating shafts respectively meshing with the plurality of teeth on the two arcuate brackets, and a gear disposed between the two rotating shafts. The two rotating shafts are respectively provided with a gear part connected with the gear. The two rotating shafts are driven when the two arcuate brackets are operated on and rotate relative to the base, thereby driving the gear to rotate. However, although the conventional hinge device is implemented through the synchronous gear assembly to provide a torsion required for rotation of the two arcuate brackets, the conventional synchronous gear assembly is likely to be unable to engage tightly due to component tolerances during an assembly process, and may even cause unsmooth rotation of the two rotating shafts and the two arcuate brackets. In addition, the conventional synchronous gear assembly occupies a large assembly space, which makes the overall hinge device unable to specifically and effectively reduce the volume. The drawbacks of the above-mentioned prior art are the defects that those skilled in the art are eager to improve.

### SUMMARY OF THE INVENTION

A main object of the invention is to solve the problem that the conventional hinge devices easily cause assembly gaps or unsmooth rotation due to component tolerances.

Another object of the invention is to solve the problem that the conventional hinge devices need to occupy a large assembly space.

In order to achieve the above objects, the invention provides a synchronous opening or closing thin hinge comprising a rotating part and a torsion providing part providing a torque required for implementation of the rotating part. The rotating part comprises a bracket and two arcuate movable members disposed on the bracket. Two tracks are formed on the bracket for the two arcuate movable members to perform an arcuate trajectory displacement respectively. The two arcuate movable members respectively comprise an arcuate section disposed on one of the two tracks, and a straight section connecting the arcuate section and extending outside of the track. Each of the two arcuate movable members is formed with a guide groove on a same side of the straight section belonging to the arcuate movable member. The torsion providing part comprises two connecting rods connecting the two arcuate movable members and displacing along the guide groove when the two arcuate movable members are displacing, two rotating shafts disposed in parallel on the bracket and driven by the two connecting rods when the two connecting rods are moving, and one swing member disposed between the two rotating shafts. The two rotating shafts are respectively provided with a plurality of teeth at positions assembling with the swing member which comprises two meshing parts that mesh with the plurality of teeth. The two meshing parts engaging with different parts of the plurality of teeth as the two rotating shafts rotating, and the swing member swings between the two rotating shafts. In one embodiment, the bracket comprises a plurality of limit blocks which restricts the two arcuate movable members disposed on the two tracks.

In one embodiment, the rotating part comprises two recessed gaps which communicate with the track provided on the bracket for disposing the two arcuate movable members.

In one embodiment, the bracket is formed with two installation grooves respectively connected to one of the two tracks. The torsion providing part comprises two torsion auxiliary providing members respectively provided in one of the two installation grooves.

In one embodiment, the two torsion auxiliary providing members respectively comprise an elastic member disposed in one of the two installation grooves, and a butting member connected to the elastic member and butting against the arcuate section by action of the elastic member. The two arcuate movable members respectively comprise a butting surface disposed on one side of the arcuate section and provided for one of the two torsion auxiliary providing members to butt against.

In one embodiment, the bracket comprises two cover plates respectively disposed in the two installation grooves and restricting the two butting members.

In one embodiment, the rotating part comprises a base connected to one side of the bracket and provided for disposing the swing member.

In one embodiment, the swing member comprises a body connected to the base, and two connecting arms which are provided with one of the two meshing parts respectively disposed on two sides of the body.

In one embodiment, the swing member is provided with an assembling groove for assembling with the base.

In one embodiment, the swing member comprises a through hole facing the base and provided for a fixing member to pass through.

Through the foregoing implementation of the invention, compared with the prior art, the invention comprises the following features: the invention is provided with the swing member in the torsion providing part, so that the swing member is capable of swinging between the two rotating shafts as the teeth engage with the two rotating shafts when the two connecting rods are opened and closed synchronously in order to provide a required torsion when the rotating part rotates. Simultaneously, through disposition of the swing member and the two connecting rods, a volume of the thin hinge is specifically reduced, and also the problem of unsmooth rotation of the conventional hinges caused by component tolerances is reduced.

### BRIEF DESCRIPTION OF THE DRAWINGS

FIG. 1 is a perspective structural view of an embodiment of the invention;

FIG. 2 is an exploded structural view of an embodiment of the invention;

FIG. 3 is a top view of an embodiment of the invention;

FIG. 4 is a top view of an operated thin hinge of an embodiment of the invention;

FIG. 5 is a side view of partial structures of an embodiment of the invention;

FIG. 6 is a side view of partial structures of an embodiment of the invention;

FIG. 7 is a cross-sectional view of an embodiment of the invention.

### DETAILED DESCRIPTION OF THE PREFERRED

### EMBODIMENTS

The detailed description and technical contents of the invention are described below with reference to the drawings.

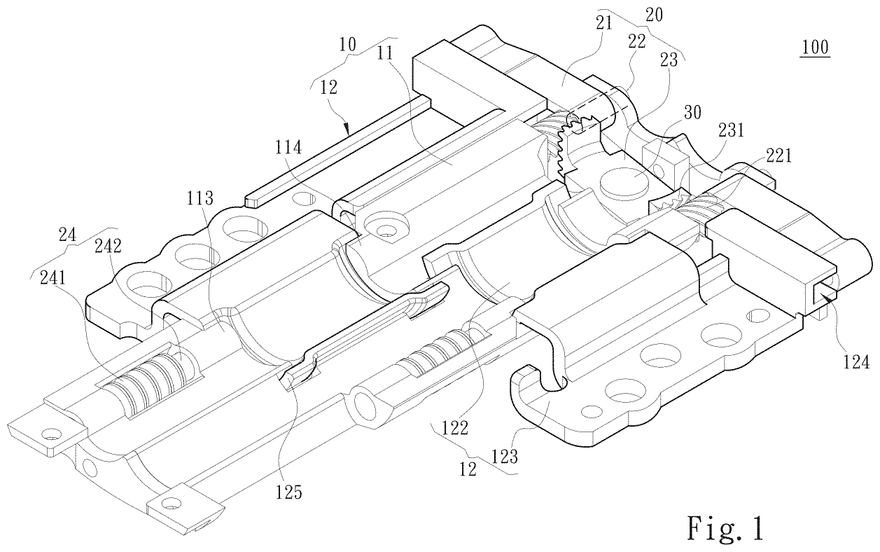

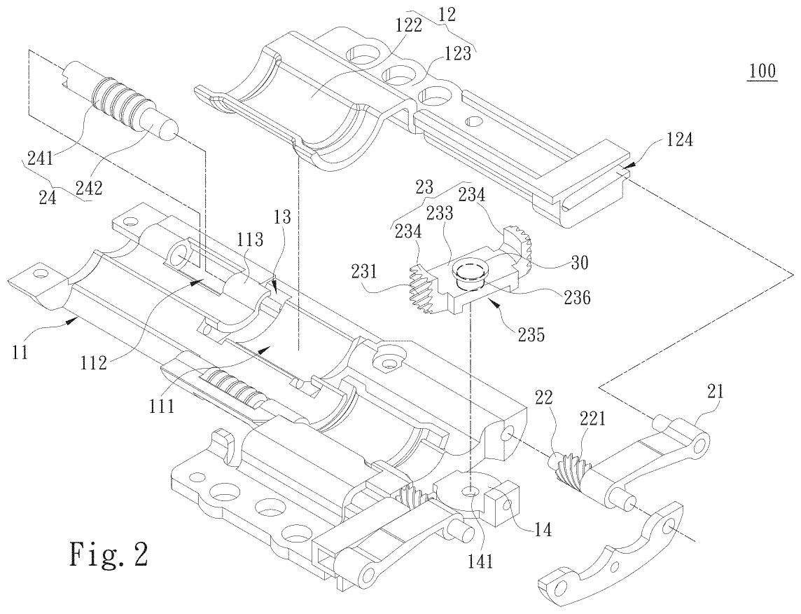

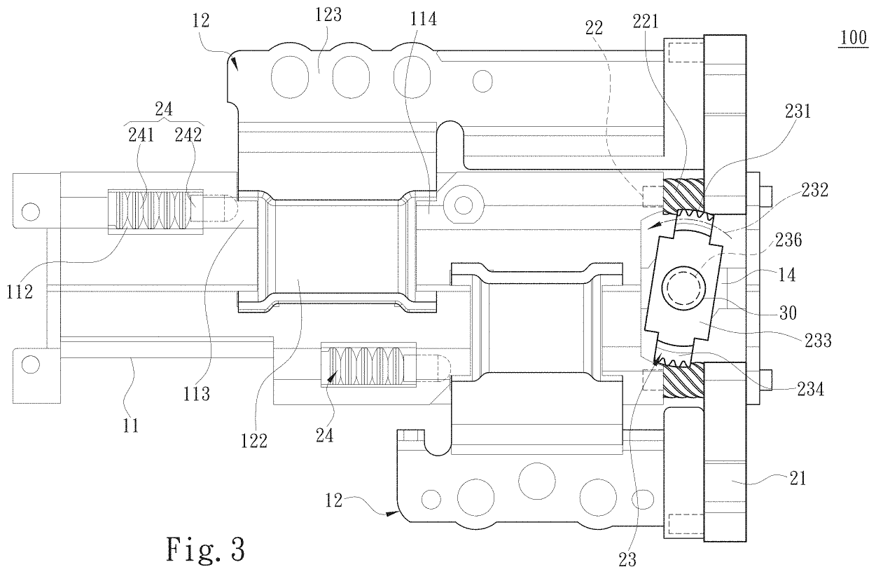

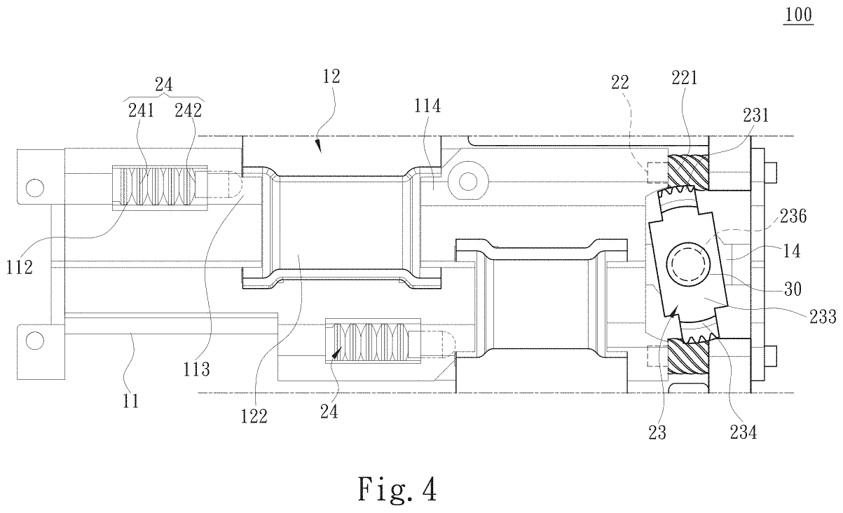

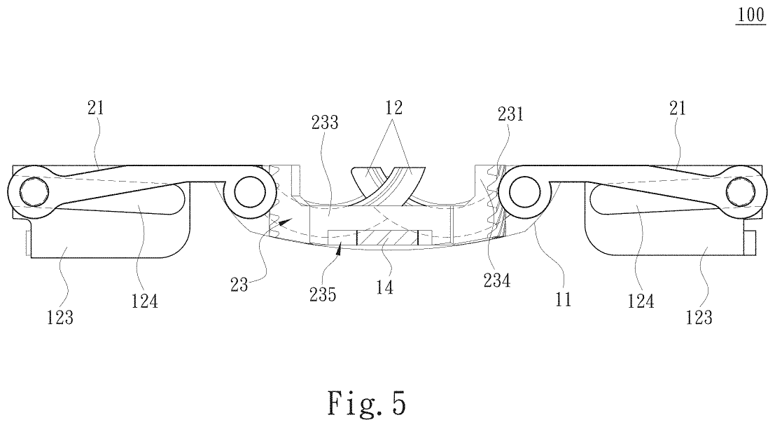

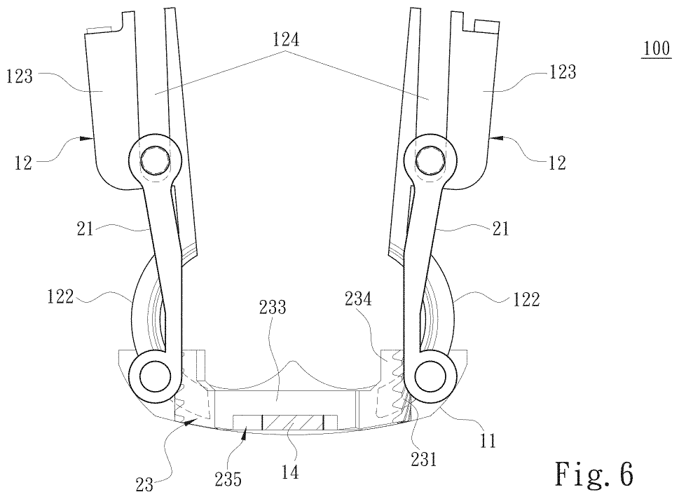

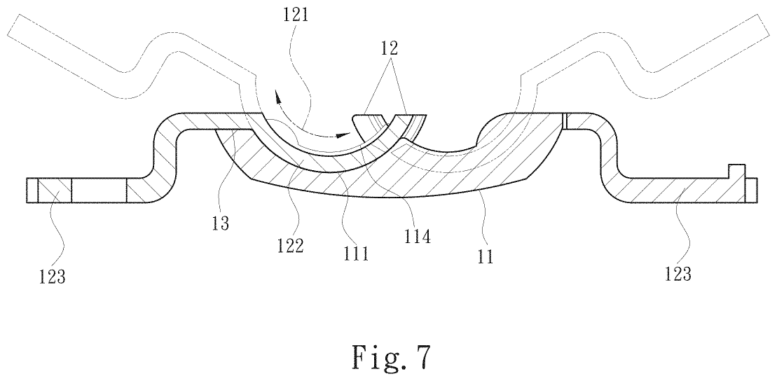

Please refer to FIG. 1, FIG. 2, FIG. 3, FIG. 4, FIG. 5, FIG. 6, and FIG. 7, the invention provides a synchronous opening or closing thin hinge 100, comprising a rotating part 10 and a torsion providing part 20. The rotating part 10 comprises a bracket 11, and two arcuate movable members 12 provided on the bracket 11. The bracket 11 is formed with two tracks 111 which are provided for disposing the two arcuate movable members 12, and allowing the two arcuate movable members 12 to respectively perform an arcuate trajectory displacement 121 when the two arcuate movable members 12 are operated. In addition, each of the arcuate movable members 12 comprises an arcuate section 122 and a straight section 123. The arcuate section 122 is provided in one of the tracks 111, and is displaced relative to the aforementioned track 111 when the arcuate movable member 12 to which the arcuate section 122 belongs performs the arcuate trajectory displacement 121. The straight section 123 is connected to the arcuate section 122 and extends outside of the aforementioned track 111. In one embodiment, the rotating part 10 comprises two recessed gaps 13 which communicate with one of the tracks 111, and the two recessed gaps 13 are provided on the bracket 11. The two recessed gaps 13 are respectively provided for disposing the straight section 123 of one of the two arcuate movable members 12, so that each of the arcuate movable members 12 is able to be closer to the bracket 11. A guide groove 124 is formed on one side of each of the two arcuate movable members 12 with the straight section 123. Two guide grooves 124 are located on a same side of the two arcuate movable members 12 to be connected with the torsion providing part 20.

The torsion providing part 20 comprises two connecting rods 21, two rotating shafts 22 and a swing member 23. The two connecting rods 21 are respectively connected to one of the arcuate movable members 12, and the two connecting rods 21 are operated to open and close relative to the bracket 11 when the two arcuate movable members 12 are moving. The two rotating shafts 22 are disposed in parallel on the bracket 11 and connected to the two connecting rods 21, and the two rotating shafts 22 are operated when the two connecting rods 21 are moving. The swing member 23 is located between the two rotating shafts 22 and is operated by the two rotating shafts 22. In detail, the two rotating shafts 22 are respectively provided with a plurality of teeth 221 at positions assembling with the swing member 23. The swing member 23 comprises two meshing parts 231 respectively meshing with the plurality of teeth 221 of the two rotating shafts 22. The two meshing parts 231 and the plurality of teeth 221 are an alternating axis helical gear structure. The different parts of the plurality of teeth 221 engage with the two meshing parts 231 as the two rotating shafts 22 are rotating, and simultaneously provide a torsion required for rotation of the rotating part 10.

Further, please refer to FIG. 3, FIG. 4, FIG. 5, FIG. 6, and FIG. 7; the implementation of the thin hinge 100 is described hereinafter. It is assumed that the thin hinge 100 is not operated and is in an open state initially, as shown in FIG. 4. Initially, the two arcuate movable members 12 are not operated, and thus the two connecting rods 21 and the bracket 11 are located on a same plane, and the swing member 23 is not displaced. When the two arcuate movable members 12 are operated by an external force to perform the arcuate trajectory displacement 121, the two connecting rods 21 are operated by the two arcuate movable members 12 and displace along the two guide grooves 124. Then, the two connecting rods 21 are erected relative to the bracket 11 after displacement, as shown in FIG. 6. Simultaneously, the two rotating shafts 22 are operated by the two connecting rods 21 to rotate, and the plurality of teeth 221 are displaced with the two rotating shafts 22. The different parts of the plurality of teeth 221 engage with the two meshing parts 231 as the two rotating shafts 22 are rotating, thereby causing the swing member 23 to displace in a counterclockwise direction (as indicated by reference numeral 232). Moreover, when the two arcuate movable members 12 receive a reverse force, the two arcuate movable members 12 perform the arcuate trajectory displacement 121 reversely, and drive the two connecting rods 21 to move, so that the two connecting rods 21 are reset to original positions. In addition, the two rotating shafts 22 are operated by the two connecting rods 21 to rotate reversely, and the different parts of the plurality of teeth 221 engage with the two meshing parts 231, so that the swing member 23 is displaced in a clockwise direction.

It can be known from the above that through the torsion providing part 20 of the thin hinge 100 of the invention is provided with the swing member 23, and the different parts of the plurality of teeth 221 of the two rotating shafts 22 engage with the swing member 23 as the two rotating shafts 22 rotates, thereby providing the torque required for implementation of the rotating part 10. Simultaneously, through disposition of the swing member 23 and the two connecting rods 21, a volume of the thin hinge 100 is specifically reduced, and also the problem of unsmooth rotation of the conventional hinges caused by component tolerances is reduced.

Please refer to FIG. 1, FIG. 2, FIG. 3, FIG. 4, FIG. 5, FIG. 6, and FIG. 7. In one embodiment, the rotating part 10 comprises a base 14 provided on one side of the bracket 11, and the base 14 is provided for disposing the swing member 23 thereon. The swing member 23 comprises a body 233 connected to the base 14, and two connecting arms 234 which are respectively provided with one of the meshing parts 231 respectively located on two sides of the body 233. Further, in order to assemble the body 233 with the base 14 stably, the body 233 is provided with an assembling groove 235, and a size of the assembling groove 235 is larger than that of the base 14. After the assembling groove 235 is assembled with the base 14, the body 233 is capable of rotating relative to the base 14. In another embodiment, the swing member 23 comprises a through hole 236 facing the base 14, and the base 14 comprises an opening 141 corresponding to the through hole 236. The through hole 236 is disposed on the body 233 and provided for a fixing member 30 to pass through. The fixing member 30 passes through the through hole 236 and then is assembled with the opening 141, thereby fixing the swing member 23 on the base 14.

On the other hand, please refer to FIG. 1, FIG. 2, FIG. 3, FIG. 4, FIG. 5, FIG. 6, and FIG. 7, in order to increase the torsion of the thin hinge 100 of the invention, in one embodiment, the bracket 11 is formed with two installation grooves 112 respectively connected to one of the tracks 111, and the torsion providing part 20 comprises two torsion auxiliary providing members 24 respectively disposed in one of the installation grooves 112. In detail, each of the torsion auxiliary providing members 24 comprises an elastic member 241 and a butting member 242. The butting member 242 is connected to the elastic member 241 which is disposed in one of the installation grooves 112. Both the butting member 242 and the elastic member 241 are located in the aforementioned installation groove 112. The butting member 242 is normally pushed and butted against by the elastic member 241 and butts against the arcuate section 122. Furthermore, in this embodiment, each of the arcuate movable members 12 comprises a butting surface 125 disposed on one side of the arcuate section 122. The butting surface 125 is provided for one of the torsion auxiliary providing members 24 to butt against. As the butting surface 125 is pushed and butted against by the aforementioned torsion auxiliary providing member 24, the arcuate movable member 12 to which the butting surface 125 belongs is capable of obtaining a greater torsion.

In addition, please refer to FIG. 1. In another embodiment, the bracket 11 is provided with two cover plates 113. The two cover plates 113 face the two installation grooves 112 and are used to restrict the two butting members 242, thereby preventing the two torsion auxiliary providing members 24 from falling off from the two installation grooves 112. On the other hand, in order to prevent the two arcuate movable members 12 from falling off, the bracket 11 is provided with a plurality of limit blocks 114. The plurality of limit blocks 114 are disposed on the two installation grooves 112 and shield each of the arcuate movable members 12 partially, thereby restricting the two arcuate movable members 12 from detaching from the two tracks 111.

What is claimed is:

1. A synchronous opening or closing thin hinge, comprising:
a rotating part, comprising a bracket and two arcuate movable members disposed on the bracket, the bracket formed with two tracks provided for the two arcuate movable members to perform an arcuate trajectory displacement respectively, each of the two arcuate movable members comprising an arcuate section disposed on one of the two tracks, and a straight section connecting the arcuate section and extending outside of the track, and each of the two arcuate movable members formed with a guide groove on a side with the straight section; and
a torsion providing part, providing a torque for the rotating part, the torsion providing part comprising two connecting rods connecting the two arcuate movable members and displacing along the guide groove when the two arcuate movable members displacing, two rotating shafts disposed in parallel on the bracket and operated by the two connecting rods when the two connecting rods moving, and a swing member disposed between the two rotating shafts, wherein each of the two rotating shafts is provided with a plurality of teeth at positions assembling with the swing member, the swing member comprises two meshing parts meshing with the plurality of teeth, the two meshing parts engaging with different parts of the plurality of teeth as the two rotating shafts rotating, and the swing member swings between the two rotating shafts.

2. The synchronous opening or closing thin hinge as claimed in claim 1, wherein the bracket comprises a plurality of limit blocks disposed on the two tracks to restrict the two arcuate movable members.

3. The synchronous opening or closing thin hinge as claimed in claim 2, wherein the rotating part comprises two recessed gaps provided on the bracket and communicating with the track for disposing the two arcuate movable members.

4. The synchronous opening or closing thin hinge as claimed in claim 1, wherein the bracket is formed with two installation grooves respectively connected to one of the two tracks, and the torsion providing part comprises two torsion auxiliary providing members respectively provided in one of the two installation grooves.

5. The synchronous opening or closing thin hinge as claimed in claim 4, wherein each of the two torsion auxiliary providing members comprises an elastic member disposed in one of the two installation grooves, and a butting member connected to the elastic member and butting against the arcuate section by an elastic action of the elastic member, and each of the two arcuate movable members comprises a butting surface disposed on one side of the arcuate section and provided for one of the two torsion auxiliary providing members to butt against.

6. The synchronous opening or closing thin hinge as claimed in claim 5, wherein the bracket comprises two cover plates respectively disposed in the two installation grooves and restricting the two butting members.

7. The synchronous opening or closing thin hinge as claimed in claim 1, wherein the rotating part comprises a base connected to one side of the bracket and provided for disposing the swing member.

8. The synchronous opening or closing thin hinge as claimed in claim 7, wherein the swing member comprises a body connected to the base, and two connecting arms respectively disposed on two sides of the body and respectively provided with one of the two meshing parts.

9. The synchronous opening or closing thin hinge as claimed in claim 8, wherein the swing member is provided with an assembling groove for assembling with the base.

10. The synchronous opening or closing thin hinge as claimed in claim 9, wherein the swing member comprises a through hole facing the base and provided for a fixing member to pass through.
